(19) United States
(12) Patent Application Publication
(10) Pub. No.: US 2014/0370165 A1
(43) Pub. Date: Dec. 18, 2014

(54) PACKAGING FOR TRANSPORTATION AND COMMERCIALIZATION OF PAPAYA

(71) Applicant: Agrícola Famosa Ltda., Aracati (BR)

(72) Inventor: Lucas DE SOUZA DIAZ GUTIERREZ, Sao Paulo (BR)

(73) Assignee: Agrícola Famosa Ltda., Aracati (BR)

(21) Appl. No.: 14/275,202

(22) Filed: May 12, 2014

(30) Foreign Application Priority Data
Jun. 17, 2013 (BR) 20 2013 015266 3

(51) Int. Cl. A23B 7/16

(52) U.S. Cl. CPC A23B 7/16
USPC 426/125

(57) ABSTRACT

A package made of plastic material for storage, transportation and commercialization of ‘formosa’ papaya, which comprises an envelope formed of a pellicle of thermoplastic film, with a plurality of orifices spaced through its surface, and sealed by a mechanized system known as flow pack, the package capable of reducing the physical damages imposed to the fruit's outer skin, lingering the ripening, and reducing the action of pathogenic agents disseminated by handling the fruit during transportation, as well as in the selling spots, adding nutritional safety to the product and reducing the losses imposed to rural producers.

### FIELD OF THE INVENTION

The present invention is in the technical field of storage, transportation and commercialization of articles especially sensitive to damages due to shock or pressure. More specifically for storage, transportation and commercialization of fruits.

### BACKGROUND OF THE INVENTION

The papaya fruit, also known as ‘papaia’ is the fruit grown from the papaya tree, a tree of the Genus Carica, probably originated from the region between Upper Amazon Basin and Central America. As a tropical plant, the papaya tree presents a better development in regions of hot and humid climate. However, due to its great acceptability, and thanks to its sensorial, nutritional and functional characteristics, added to its adaptability and to works involving genetic improvement, had its cultivation extended also to subtropical regions, being currently present in more than sixty countries, being Brazil considered as its greater world producer and third major exporter.

The consumption of papaya fruit is recommended by several nutritionists for being rich in vitamins A, C and of B complex, source of mineral salts such as calcium, potassium and magnesium, it also possesses the papain, a special enzyme that digests proteins, helps to absorb nutrients and in the good functioning of the digestive system. The more mature it is, the greater the concentration of those nutrients in the fruit, which may be consumed daily to help balance the human organism.

The two varieties of papaya commonly found in Brazil are called ‘papaia’ and ‘formosa’. The papaya of variety ‘papaia’ is smaller and more sweetish, weighing between 300 g and 1 kg, while the papaya of variety ‘formosa’ may reach 3 kg, which makes it more adequate for utilization where there is a great demand of fruit pulp.

Papaya fruits are classified, as for the respiratory standard, as climacteric, that is, they can ripe after being harvested, influenced by factors such as temperature and atmospheric composition and, regarding this aspect, there are several studies that highlight the importance of quality conservation for papaya commercialization, as this fruit is consumed preferably in its natural state.

The papaya's outer skin is very sensitive to mechanical shocks, being damaged just by a soft friction with the package utilized in its transportation, commonly made of cardboard or wood. Such damaging effect is potentialized due to the form of presentation of those fruits exposed in baskets and shelves without refrigeration. The main characteristics that determine the picking of fruits by final consumers are the absence of physical damages, hardness and coloration, and the processes of packaging, transportation and handling practiced currently at production and commercialization centers, hit negatively the quality of the fruit to be commercialized, accelerating the process of deterioration of the fruits, generating post-harvest losses of up to 75% in some cases.

In the state of the art, there are documents mentioned that present proposals to fulfill such deficiencies.

Brazilian document MU7601265-4 describes an arrangement introduced in an articulated disposable package for papayas, made preferably in PVC or similar, being equipped basically of two articulated parts among each other by means of central grooves, being that each referred part presents a series of parallel cavities, similar to a papaya's half, in such a way that when both parts are closed to one another, the cavities acquire the papaya format, for successive and parallel sheltering of as many fruits as are the cavities.

Brazilian document MU8401983-2, describes a package for papaya that comprehends a semi-rigid tray molded with plastic material or similar, presenting a surface with cavities molded in an oblong format that permits accommodating papayas in an individual way, including a depression region for peduncle protection.

The Brazilian document MU8602534-1 describes a papaya packaging, preferably prepared for accommodating the ‘papaia’ type, capable of accommodating four fruits, which remain stored in the direction of its vertical axis, containing orifices and openings for air circulation, avoiding the late ripening of the fruit.

Despite the packages described in the state of the art protect the fruits from physical damages and other damages; they are destined for transportation of papayas from production areas to the commercialization locations, not being adequate for exhibition and bulk commerce of papaya fruits in markets or similar establishments.

This way, the state of the art still misses packages for bulk commerce of papaya fruits, which can preserve the fruit's natural characteristics, reducing the physical damages that can be imposed to them, as well as its perishable capacity, reducing the losses at agricultural production and warranting the profitability of rural producers.

### SUMMARY OF THE INVENTION

The present invention describes a package produced in thermoplastic film, destined to the transportation and commercialization of ‘formosa’ papaya, which permits a drastic reduction of losses caused to the fruit after its harvesting, improves product presentation at selling spots and provides a higher shelf life at commercialization locations.

The present invention comprises a package in the format of an envelope, produced in a thermoplastic film, with a plurality of orifices spaced in its surface. Its sealing is made by a mechanized system known as “flow pack”. The procedure has shown to be specially useful when applied to the papaya of ‘formosa’ variety, which presents big and large fruits, as it reduces the physical damages imposed to the fruit's outer skin, and leads the product to ripe more slowly, reducing the action of pathogenic agents disseminated by handling the fruit during the transport, as well as the selling spots, adding nourishing safety to the final product and better profitability to rural producers.

### BRIEF DESCRIPTION OF THE DRAWINGS

FIG. 1 shows a view in perspective of the package with a ‘formosa’ papaya already packaged in its interior.

FIG. 2 shows a view in perspective of a package configuration with a greater number of orifices in its surface.

FIG. 3 shows a view in perspective of a package configuration with a lesser number of orifices in its surface.

FIG. 4 shows a ‘formosa’ papaya in its several harvesting spots.

### DETAILED DESCRIPTION OF THE INVENTION

The main form of commercialization of ‘formosa’ papaya for the final consumer is in bulk, that is, the product is exhibited in shelves with no refrigeration, unpacked and sold in units, especially for being a fruit of big dimensions, which can reach to a weight of up to 3 kg. Such form of commercialization exposes the product to physical damages and to pathogenic agents, besides increasing the fruit's respiratory rate, which leads to ripe more rapidly, once there is no inhibition for the natural production of the ripe hormone (ethylene).

In the preferred embodiment, package (A) for ‘formosa’ type papaya, permits reducing the mechanical damages imposed to the fruit's outer skin due to its transport and handling, improves the product's hygiene, increases the post-harvest life and provides to the consumer a more tasty and nutritive product, as the fruit can be harvested with more ripening, a stage in which the presence of vitamins A, C and B, mineral salts and its own papain present more elevated levels.

By using the proposed invention, such effects will remain evident after reading the detailed description below.

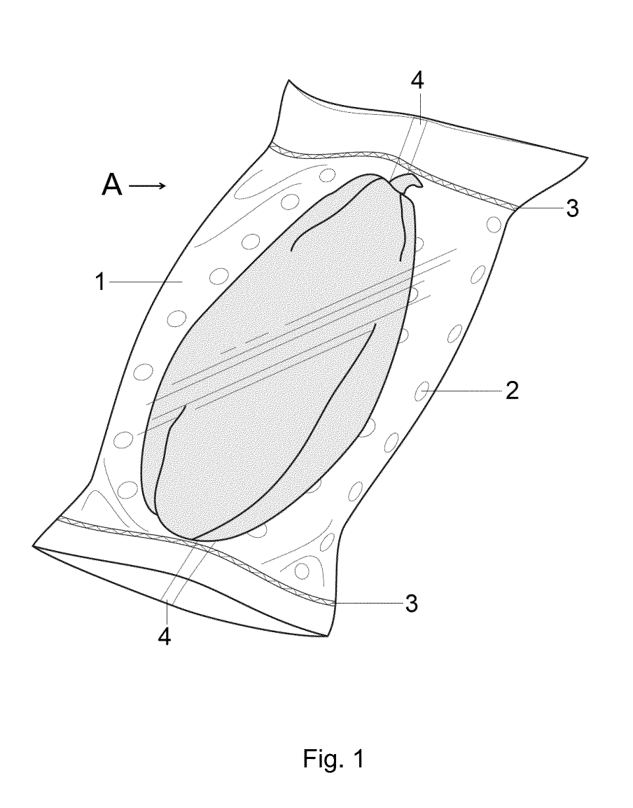

Package (A), according to FIG. 1, comprises a pellicle (1) of thermoplastic film made of bi-oriented polypropylene (BOPP) or polyethylene (PE), with paper density in the range of 55 to 65 g/m₂, folded over itself in such a way to form an envelope capable of entirely involving the fruit. The package containing a plurality of orifices (2), distributed in two parallel rows, near the lateral and in the longitudinal direction of package (A), separated among each other in about 10 to 35 mm; and two points of horizontal sealing (3) at the upper and lower ends of the package (A), and a point of vertical sealing (4), at the central part of the package (A), in order to obtain a substantially rectangular final aspect.

The sealing is made in a mechanical form in a machine that uses the flow pack sealing system.

The smooth surface of package (A) reduces the mechanical damages that can be imposed to the papaya's outer skin, by the simple abrasion originated by the skin attrition with packages, commonly made of cardboard or wood, utilized in its transportation to the commercialization areas, which leads to the appearing of lesions that afterwards transform themselves into rotten spots, which may turn the installation of fungus and/or bacteria in the fruit possible, changing its flavor and making them improper for consumption.

Normally, the ‘formosa’ papaya is washed with a chlorine solution at 100 ppm and waxed with nutritious wax before being transported to the selling spots, however, at the baskets or shelves of supermarkets, the fruits are handled by several customers, which may contaminate the product with several pathogenic agents, such as excremental matters, listeria, etc. The package (A), as described here, isolates the ‘formosa’ papaya from these probable contaminant agents, which provides a better nutrition safety to the customer.

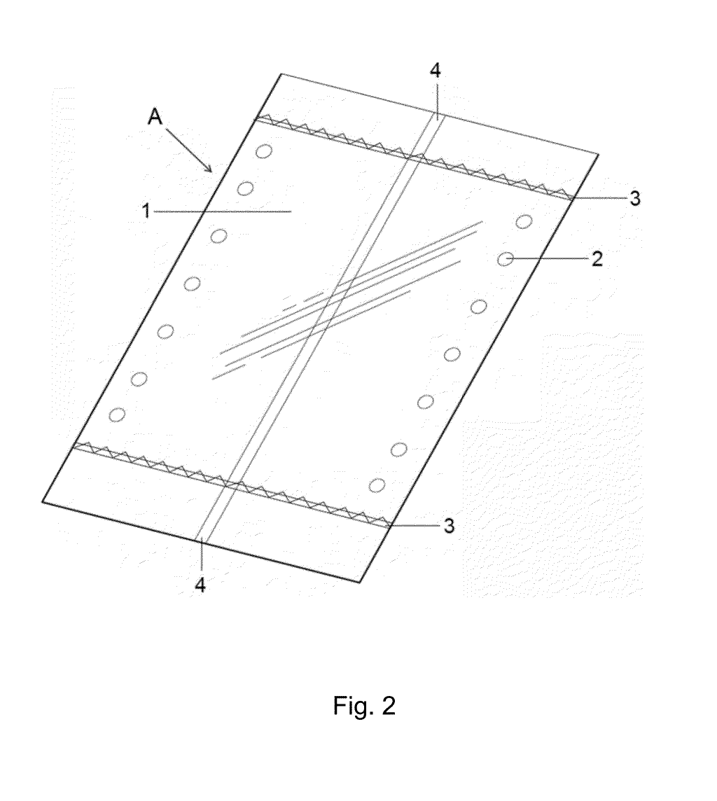

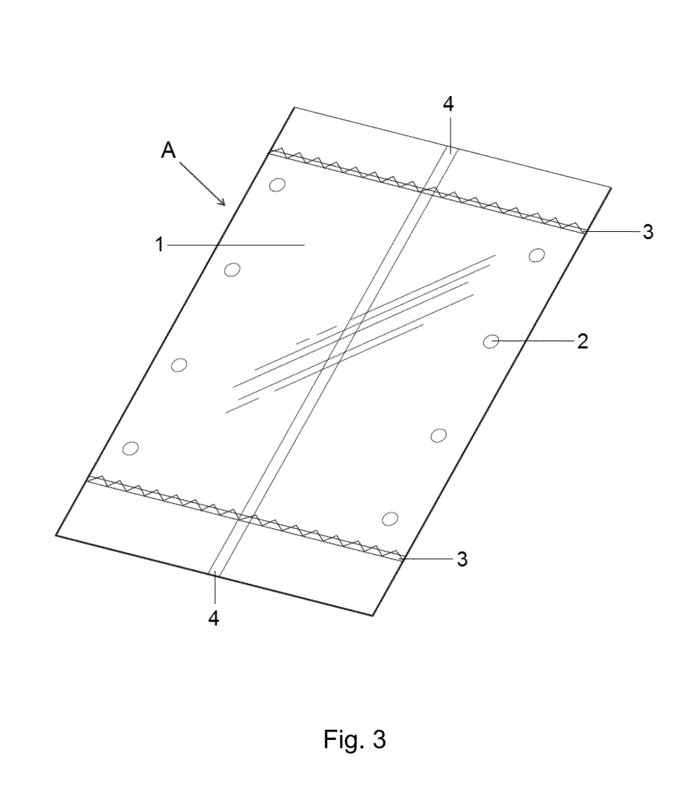

The quantity of orifices (2) applied at the surface of pellicle (1) of package (A)'s thermoplastic film varies according to the period of the year. In the summer, with higher temperatures, the respiratory rate is greater, demanding to increase the quantity of orifices (2), arranging them in parallel and separated between 10 to 20 mm among each other, in the longitudinal direction of package (A), in order to not occurring the process of anaerobic fermentation by excess of CO₂, as shows FIG. 2. In the winter, the quantity of holes may be decreased, as presented in FIG. 3, increasing the distance among them to 15 to 35 mm. This will prolong even move the product's post-harvest life.

The utilization of package (A) provides a reduction of the respiratory rate of ‘formosa’ papaya and an increment in the concentration of CO₂, which leads the product to ripe more slowly, once CO₂ actuates in the inhibition of ethylene (ripe hormone).

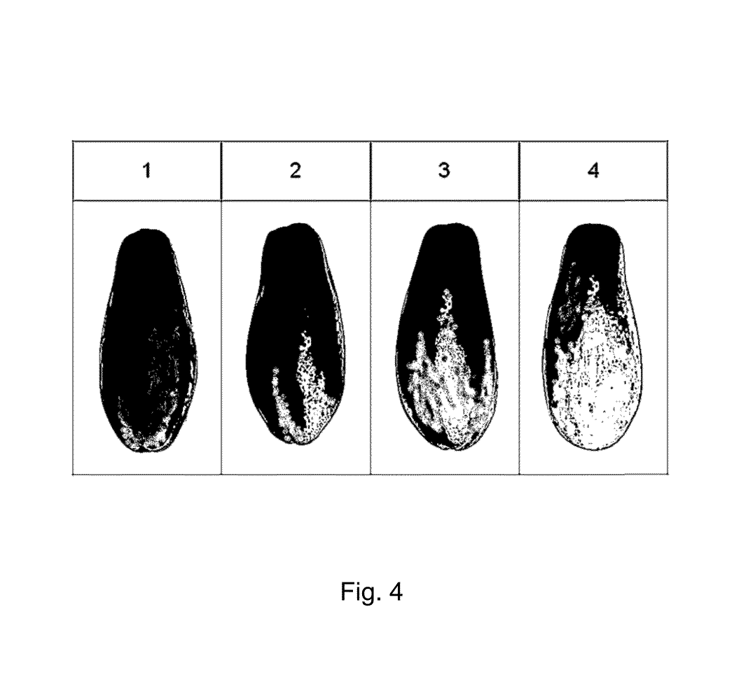

The harvest points for ‘formosa’ papaya are indicated in Table I below, whose comprehension may be helped by examination of FIG. 4.

As a general practice, the ‘formosa’ papaya is harvested practically unripe, at harvest point 1, as it ripens quickly, the harvest in this stage warrants a greater time so that it is distributed and exposed at the markets.

With the utilization of package (A), it is possible to proceed with the harvest at point 3, where the product already reached its physiological ripeness without losing its characteristics of hardness and coloration, appreciated by consumers.

TABLE I

| | Point of harvest | | | |
|---|---|---|---|---|
| | 1 | 2 | 3 | 4 |
| Fruit | First yellow | Fruit normally | The fruit | Colored fruit that |
| Characteristics | signs at skin, | presents two | presents more | presents 50% of |
| | always in the | well visible | than 35% of the | yellowish skin |
| | direction of base | yellow stripes, | yellowish skin | surface and may |
| | to peduncle. The | with 25% to 35% | surface and may | reach up to 75%. |
| | yellow color shall | of the yellowish | reach up to 50%. | |
| | not cover more | skin surface. | | |
| | than 10% of the | | | |
| | skin. | | | |

Researches revealed that when papaya is not packaged, it loses approximately 3.5% of its weight due to water evaporation that is contained in its cellular structure, when reaching its commercialization spots. However, with the utilization of the package (A), this value is reduced to 0.7%, providing a greater post-harvest life and a better visual aspect, once even mellowed, it will not have a wilted appearance, as it happens in the conventional commercialization form.

Package (A), besides the characteristics already described, yet allows the printing over the pellicle (1) of thermoplastic film, information that fulfill the legal exigencies of the inspection agencies, such as for example: information on the producer and its origin, the date of harvest/validity, ideal conservation conditions, the product's weight and nutritional value, among others.

The characteristics of package (A) for ‘formosa’ papaya, must not be limited to what was described here and illustrated by the figures, or only through the claims that follow, as those skilled with the technique may reach to possible variations, without escaping from the scope of this document.

1. A package for transportation and commercialization of ‘formosa’ papaya, comprising:
a pellicle (1) of thermoplastic film made of bi-oriented polypropylene (BOPP) or polyethylene (PE), with paper weight in the range of 55 to 65 g/m₂, folded over itself in such a way to forming an envelope capable of entirely involving the fruit and containing:
(a) a plurality of orifices (2), applied at the surface of pellicle (1) and distributed in two parallel rows, near a lateral and in a longitudinal direction of package (A), separated among each other in about 10 to 35 mm, and
(b) two points of horizontal sealing (3) at an upper and lower ends of package (A), and a point of vertical sealing (4) at a central part of package (A), to obtain a final aspect substantially rectangular.

2. The package according to claim 1, wherein in periods of higher temperatures, the orifices (2), applied at the surface of pellicle (1) of thermoplastic film for package (A), are distant from 10 to 20 mm from each other.

3. The package according to claim 1, wherein in periods of lower temperatures, the orifices (2), applied at the surface of pellicle (1) of thermoplastic film for package (A), are distant from 15 to 35 mm from each other.
